(19) United States
(12) Patent Application Publication
(10) Pub. No.: US 2019/0027330 A1
(43) Pub. Date: Jan. 24, 2019

(54) MULTIPLE LOCATION ELECTRICAL CONTROL SYSTEM

(71) Applicant: Thomas Glen Coon, Goodyear, AZ (US)

(72) Inventor: Thomas Glen Coon, Goodyear, AZ (US)

(21) Appl. No.: 16/016,424

(22) Filed: Jun. 22, 2018

Related U.S. Application Data
(60) Provisional application No. 62/535,960, filed on Jul. 23, 2017.

(51) Int. Cl. H01H 47/00; H02J 7/00; F21S 9/03; H05B 37/02; H01R 25/00; H01R 13/70; H01R 31/06

(52) U.S. Cl. CPC H01H 47/00; H02J 7/0052; F21S 9/037; H05B 37/0209; F21Y 2115/10; H01R 13/701; H01R 31/065; H02J 2007/0062; H01R 25/003

(57) ABSTRACT

An electrical control device comprising a first housing and a second housing. The second housing further comprises a non-latching mini power relay, a controlled/uncontrolled receptacle, and a common three-way or four-way, switch. The first housing is preferably an isolated controlled and uncontrolled circuit pass-through which is wired to the housing comprising the non-latching mini power relay in such a way to mimic a three-way or four-way switch. The electrical control device may further comprise at least one built-in night light, at least one USB charging port for various devices and/or a remote circuit configured to allow switching from a handheld wireless device.

### CROSS REFERENCE TO RELATED APPLICATION

The present application is related to and claims the benefit under 35 U.S.C § 119(e) of the prior U.S. provisional application Ser. No. 62/535,960 filed Jul. 23, 2017 entitled “THREE-WAY SWITCHING DEVICE FOR CONTROLLING A LAMP FROM AN EXISTING SINGLE-POLE WALL SWITCH CONTROLLING A HALF/SPLIT-CONTROLLED WALL RECEPTACLE”, the contents of which are incorporated herein by this reference in their entirety, and are not admitted to be prior art with respect to the present invention by the mention in this cross-reference section.

### FIELD OF THE INVENTION

The present invention relates generally to the field of electrical control devices. In particular, the present invention relates to a device that allows a user to control at least one electrical device from two or more locations in a room utilizing an existing half/split-controlled wall receptacle powered from a single-pole or three-way switch.

### BACKGROUND OF THE INVENTION

Modern homes are utilizing more and more half/split controlled wall receptacles in almost every room of the home. Current lamp control devices on the market do not allow a user to control the half/split controlled wall receptacles from other areas in the room such as night stands, end tables or desks. Once a controlled wall switch is turned off lamps cannot be turned on from any other location in the room, including the lamp itself, within the controlled circuit. The user must navigate a dimly lit room as they go back to the wall control switch usually located at the entrance of the room.

Another drawback is a lamp that is turned on in a room from a controlled wall switch. While it's convenient to turn the lamp on using the wall switch when entering the room after dark, it's more convenient to use the switch on the lamp to turn it off when retiring. As a result, in the morning, when the room is well lit by daylight, the bedside lamp switch is typically left switched off. At night time, when the room is reentered, the wall switch cannot be used to turn the lamp on again, thus forcing the user to navigate the room and search for the lamp switch in the dark.

Therefore, a need exists that allows a user to control lamps from night stands, end tables, and desks independent of the wall switch regardless of the on or off position of the single-pole wall switch, giving the user a true three-way switch function from an existing single-pole switch controlling a half/split-controlled wall receptacle.

For ease of installation and to limit expenses, it is desirable to have a filed installable control device that can be used without requiring modifications to the existing wall switch, or the lamp, without modifying the existing wall receptacle or any other parts of the existing wiring.

Any discussion of prior art throughout the specification should in no way be considered as an admission that such prior art is widely known or forms part of the common general knowledge in the field.

### BRIEF SUMMARY OF THE INVENTION

According to the present invention there is provided an electrical control device comprising a first housing and a second housing. The second housing further comprises a non-latching mini power relay, a controlled/uncontrolled receptacle, and a common three-way or four-way, switch. The first housing is preferably an isolated controlled and uncontrolled circuit pass-through which is hardwired to the housing comprising the 120 volt 10 amp double pole double throw non-latching mini power relay in such a way to mimic a three-way or four-way switch.

In addition, a second electrical control device comprising a second first housing and second housing can be used to expand the switch circuit option. The second first housing and second housing would be wired the same as the lamp control device outlined above.

According to one aspect of the present invention there is provided an electrical control device further comprising at least one built-in night light.

According to another aspect of the present invention there is provided an electrical control device further comprising at least one USB charging port for various devices.

According to another aspect of the present invention there is provided an electrical control device further comprising a remote circuit configured to allow switching from a handheld wireless device.

According to another aspect of the present invention there is provided an electrical control device further comprising an end housing which can be used to add an additional multipole switch option.

### BRIEF DESCRIPTION OF THE DRAWINGS

The preferred embodiment of the present invention will now be described, by way of example only, with reference to the accompanying drawings in which:

FIG. 1A shows a perspective view of a Multiple Location Electrical Control System according to the preferred embodiment of the present invention;

FIG. 1B shows an electrical diagram of a Multiple Location Electrical Control System according to the preferred embodiment of the present invention

FIG. 2A is a perspective view of a first housing of a Multiple Location Electrical Control System according to the preferred embodiment of the present invention;

FIG. 2B shows an electrical diagram of the first housing of a Multiple Location Electrical Control System according to the preferred embodiment of the present invention;

FIG. 3A shows a perspective view of a second housing of a Multiple Location Electrical Control System according to an alternate embodiment of the present invention;

FIG. 3B shows an electrical diagram of the second housing for a Multiple Location Electrical Control System according to the preferred embodiment of the present invention;

FIG. 4A shows a perspective view of an end housing for a Multiple Location Electrical Control System according to an alternate embodiment of the present invention; and

FIG. 4B shows an electrical diagram of the end housing for a Multiple Location Electrical Control System according to an alternate embodiment of the present invention.

### DETAILED DESCRIPTION OF THE INVENTION

The foregoing and other objectives, features, and advantages of the invention will be more readily understood upon consideration of the following description of the invention taken in conjunction with the accompanying drawings.

In this application, the terms controlled and uncontrolled are related to the electrical conductivity of an outlet and/or switch. Controlled is defined herein as a conductor that is controlled by an electrical switch. Uncontrolled is defined herein as a conductor that is not controlled by an electrical switch. A split/half-controlled circuit is defined herein as a circuit with one controlled conductor and one uncontrolled conductor. For the purposes of description of this invention, a wire may contain multiple separate conductive elements, called conductors. Further, for the purposes of description of this patent, the term wire is used to describe a single or multi-conductor cable.

In one preferred embodiment, the present invention comprises a first housing adapted to plug into an existing electrical half/split receptacle, a second housing with a switch connected to the first housing by a 6-conductor wire, and an end housing with a multiple pole switch connected to the second housing by a 6-conductor wire. In this preferred embodiment, power to a switched outlet can be turned on and off from the previously existing switch that controls the controlled/uncontrolled split receptacle, the multiple pole switch on the second housing, and the multiple pole switch on the end housing.

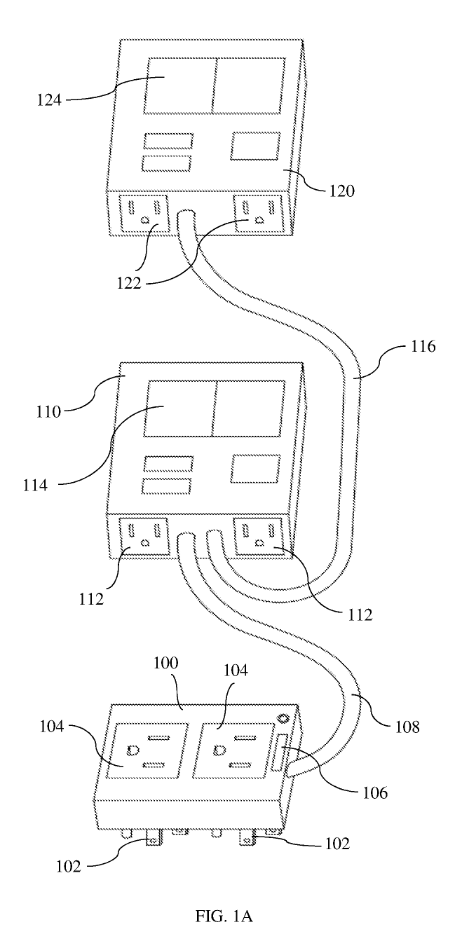

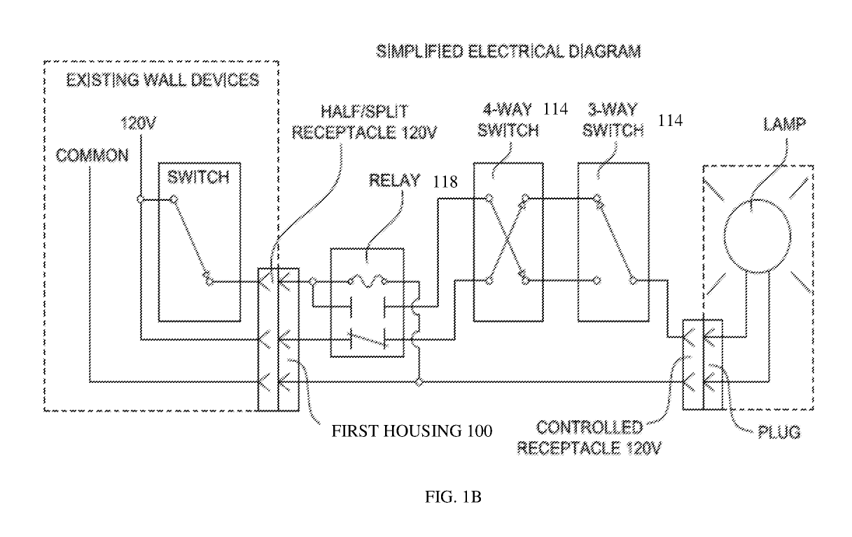

Now referring to the drawings, FIG. 1A and FIG. 1B show a Multiple Location Electrical Control System preferably capable of controlling a lamp or other electrical devices from two or more locations utilizing an existing single-pole wall switch and a half/split-circuit receptacle comprising: a first housing 100, a second housing 110, and an end housing 120. In this preferred embodiment the multiple location electrical control system comprises the first housing 110 connected to the controlled/uncontrolled receptacles in the wall outlet, an electrical relay, and at least one switch. Alternately preferably, the system may contain two or more multiple pole switches, and one or more controlled or uncontrolled electrical outlets.

The first housing 100 of FIGS. 1A and 1B further comprises in electrical connection at least two sets of male pronged grounded power input plugs 102, and a first conductor cable 108 leading to the second housing 110. Alternately preferably, the first housing 110 may include at least one controlled electrical receptacle 104, at least one uncontrolled electrical receptacle 104, a non-latching relay, and a first conductor cable 108 leading to the second housing 110.

As further shown in FIGS. 1A and 1B, the multiple location electrical control system further comprises a second housing 110. The second housing 110 further comprises in electrical connection a non-latching electrical relay 118, a multiple pole switch 114, at least one controlled electrical receptacle 112, at least one uncontrolled electrical receptacle 112, and a second conductor cable 116 electrically connecting the first housing 100 to the second housing 110. Alternately preferably, when the non-latching electrical relay is enclosed in the first housing 100, the second housing 110 may be connected to the first housing 100 by a 6-conductor cable 108 and provide only a switch with no additional electrical receptacles.

As further shown in FIGS. 1A and 1B, the multiple location electrical control system preferably further comprises an end housing 120. In this preferred embodiment the end housing 120 is electrically connected to the second housing 110 by the second conductor cable 116, preferably a 4-conductor cable. In this preferred embodiment the end housing 120 comprises at least one controlled and at least one uncontrolled electrical receptacles 122, and at least one multiple pole switch 124. Alternately preferably, the second cable 116 electrically connecting the end housing 120 to the second housing 110 may comprise a 6-conductor cable. Alternately preferably, the end housing 120 may comprise a multiple pole switch 124 without an electrical receptacle.

As shown in FIG. 1B, the first housing 100 preferably comprises at least two connections to an existing split controlled/uncontrolled electrical receptacle which would already exist in the building. Further, as shown in FIG. 1B, in this preferred embodiment, the multiple location electrical control system further comprises at least one 120-volt double-pole double-throw (DPDT) non-latching relay in electrical connection with the at least two sets of male pronged grounded power input plugs and the at least one controlled electrical receptacle and the at least one uncontrolled electrical receptacle. In this preferred embodiment, the at least one non-latching relay preferably further comprises at least two contacts, preferably one normally open contact and one normally closed contact.

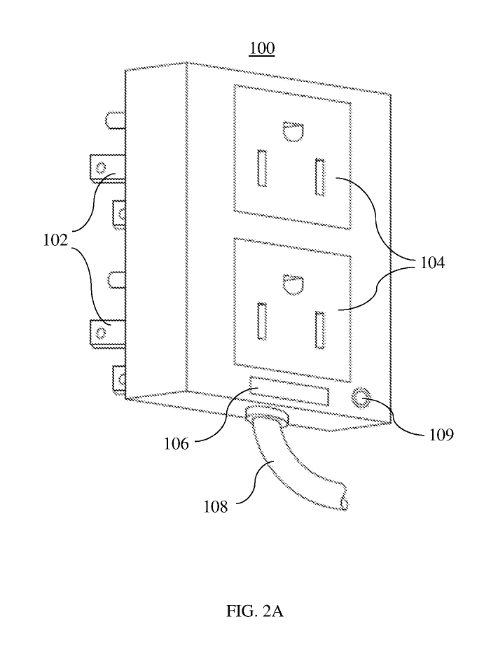

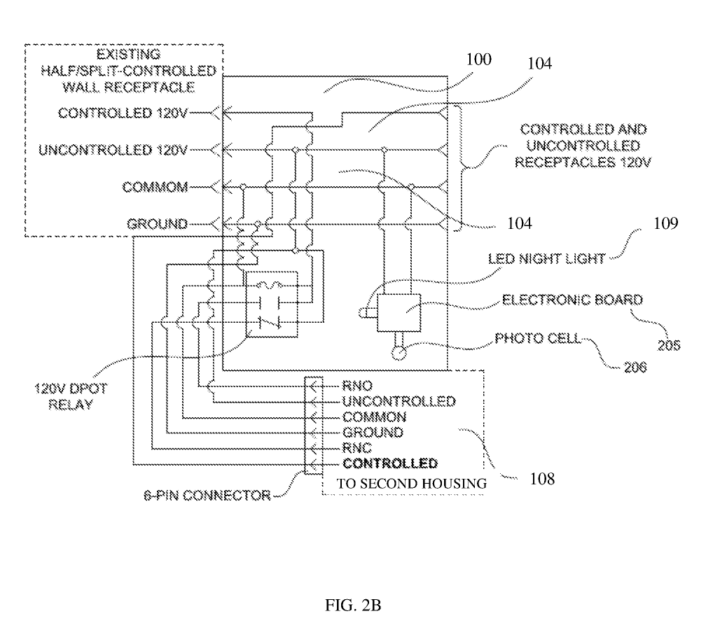

As further shown in FIGS. 2A and 2B, the first housing 100 plugs into an existing half/split-controlled household wall outlet controlled by an existing conventional single-pole, single-throw wall switch. The controlled 120V side of the circuit connects to the upper male pronged grounded power input plug 102 of the first housing 100 and passes through the first housing to the upper controlled electrical receptacle 104 on the face of the first housing 100 to provide a controlled power source. The common side of the circuit connects to the opposite side of the lower male pronged grounded power input plug 102 and passes through the first housing 100 to both the controlled and uncontrolled electrical receptacles 104 on the face of the first housing. The 120V side of the lower male pronged grounded power input plug of the first housing 100 connects to the half/split wall outlet to the direct electrical power of the circuit creating an uncontrolled circuit and passes through the first housing to the lower uncontrolled electrical receptacle on the face of the first housing to an uncontrolled power source.

Alternately preferably, the first housing 100 may comprise a switch or jumper on its back face (the face with male prongs placed into the existing household outlet) so that it can be adapted in the event that the positions of the controlled and uncontrolled outlets are reversed in the existing half/split-controlled household wall outlet, the multiple location electrical control system can be adapted to the existing household wall outlet.

As shown in FIG. 2A, the first housing 100 is preferably fully enclosed within a non-metallic, non-conductive material. The at least two sets of male pronged grounded power input plugs 102 are preferably structured to fit into a standard split/half-controlled wall electrical socket such that each of the at least two sets of male pronged grounded power input plugs 102 preferably extend outwardly from one surface of the first housing 100. At least one set of the male pronged grounded power input plugs 102 is preferably wired to plug into the controlled half of the wall socket, and at least one of the male pronged grounded power input plugs 102 is preferably wired to plug into the uncontrolled half of the wall socket. The controlled set of male pronged grounded power input plug is preferably electrically isolated from the uncontrolled set of male pronged grounded power input plug.

As further shown in FIGS. 2A and 2B, the at least one controlled and at least one uncontrolled receptacles 104 are preferably located on an opposite face of the first housing 100 to the at least two sets of male pronged grounded power input plugs 102. The at least one controlled receptacle and at least one uncontrolled receptacle are preferably standard three-pronged receptacles. In an alternate embodiment, the first housing 100 preferably further comprises an LED night light 109 in the outside face of the first housing. In this alternate embodiment, the LED night light 109 is mounted to an electrical board 107 (as shown in FIG. 2B) electrically coupled to the uncontrolled power circuit. The LED night light 109 may be operated by the electricity provided by the electrical circuit or may be provided by a photo cell 206 also electrically connected to an electrical board 205 within the first housing 100.

As shown in FIG. 2B, the first housing preferably provides two outlets that electrically are connected to pass through to the underlying existing household wall outlet. As further shown in FIG. 2B both the controlled and uncontrolled, as well as a ground and common wire, are sent out through a 4-conductor wire to lead to the second housing. Alternately preferably, the first housing 100 may further comprise the DPDT relay 105 within the housing as shown in FIG. 2B.

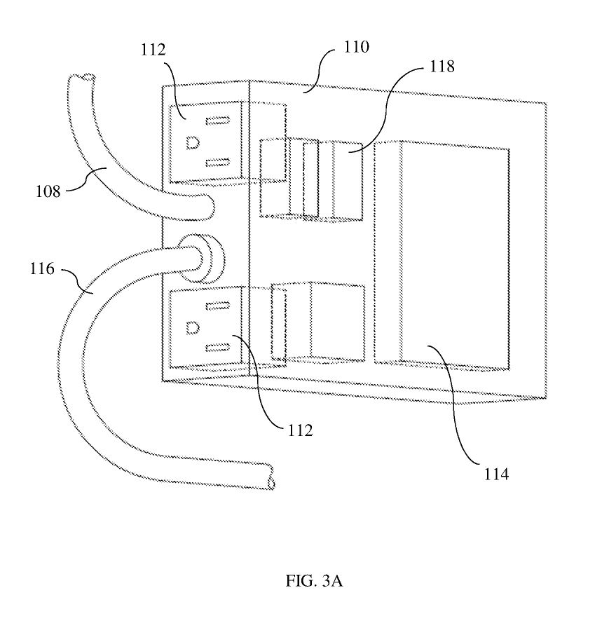

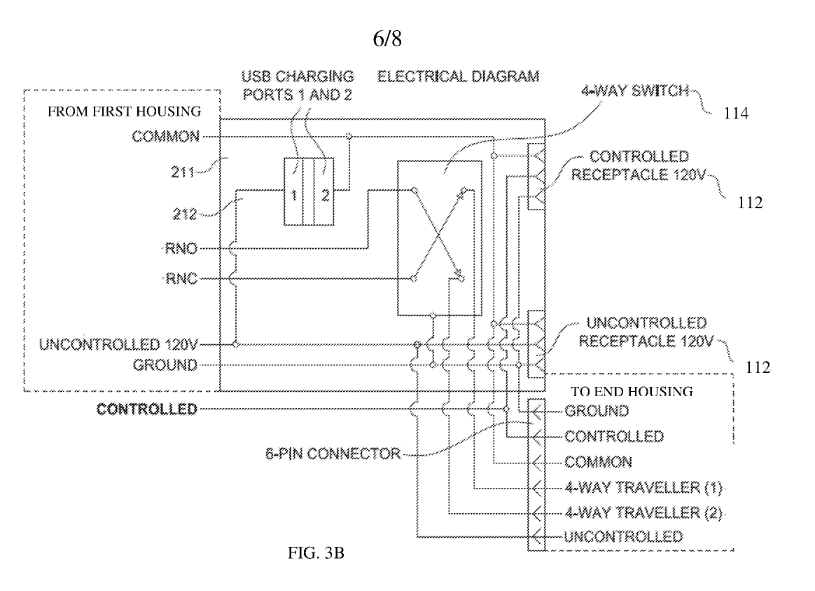

As shown in FIGS. 3A and 3B, a second housing 110 is preferably fully enclosed in a non-metallic, non-conductive material, and electrically coupled to the first housing preferably using a first conductor cable 108. The first conductor cable 108 is preferably electrically connected to the controlled, uncontrolled, and common of the respective male pronged grounded power input plugs in the first housing. The first conductor cable 108 is preferably a #16 4-conductor wire that is preferably hardwired to the first housing. In an alternate embodiment, the first conductor cable 108 is hardwired to the second housing 110 on a first end and comprises an electrical plug on a second end. In this alternate embodiment, the first housing would further comprise a receptacle for the wire electrical plug. The first housing preferably further comprises at least one controlled electrical receptacle and at least one uncontrolled electrical receptacle in a face of the housing.

As further shown in FIGS. 3A and 3B, the second housing 110 preferably further comprises a DPDT relay connected to a multiple pole switch 114, commonly called a 3-way switch or a 4-way switch. The DPDT relay is electrically connected to at least one controlled electrical receptacle 112 and at least one uncontrolled electrical receptacle 112, by way of a first conductor cable 108, preferably a 4-conductor cable, electrically connecting the second housing 110 to the first housing. Alternately preferably the second housing 110 may comprise the DPDT relay and a switch without the electrical receptacles 114. Alternately preferably, if the DPDT relay is located in the first housing, the second housing 110 may be connected by using a 6-conductor cable to the first housing. Alternately preferably, the second housing 110 may also comprise USB charging ports 118, 211.

In an alternate embodiment, the second housing 110 may further comprise a remote circuit electrically connected to the DPDT relay 212. In this alternate embodiment, the remote circuit would comprise an electrical board using a wireless communication to operate the switch from a remote device such as a mobile phone or other smart device. Alternately preferably, the remote circuit is located within the end housing.

As shown in FIG. 3B, the second housing preferably further comprises at least one uncontrolled USB charging port 211 electrically connected to the uncontrolled circuit. The slot for the USB charging port 118 is preferably located on at least one face of the second housing 110, as previously shown in FIG. 3A.

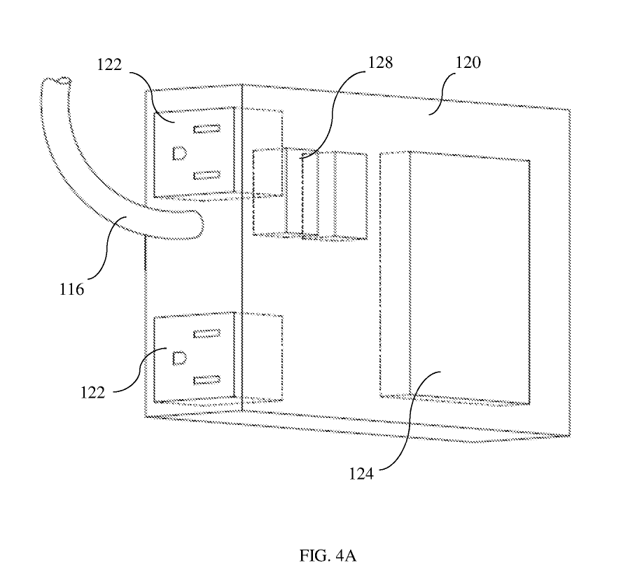

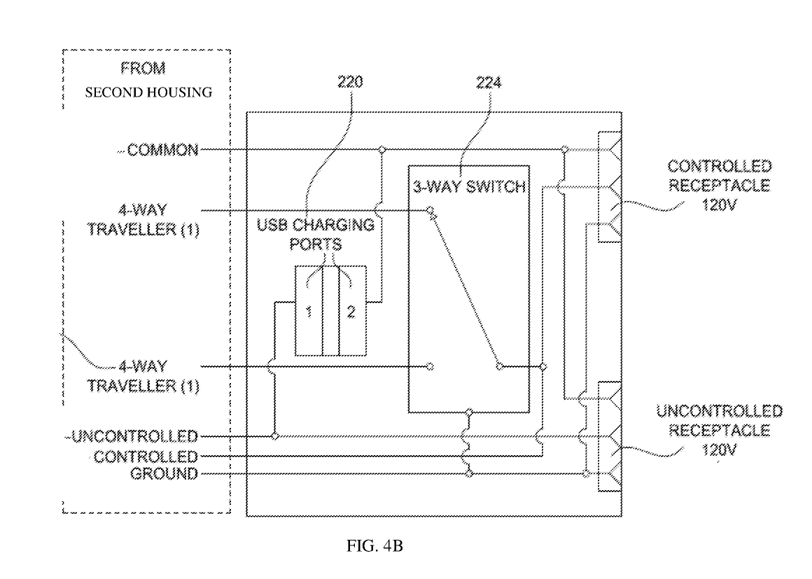

In an alternate embodiment shown in FIGS. 4A and 4B, an end housing 120 is preferably electrically coupled to the second housing to provide an expanded switch 124. The end housing 120 is preferably fully enclosed in a non-metallic, non-conductive material, and electrically coupled to the second housing preferably using a second conductor cable 116. The second conductor cable 116 is preferably a #16 6-conductor cable that is preferably hardwired to the second housing 120. In this alternate embodiment, the second housing would further comprise a 6-conductor wire to extend to the end housing. In this preferred embodiment the end housing 120 would contain an additional multiple-pole switch 124, 224, which is preferably a 3-way switch. The end housing 120 preferably further comprises at least one controlled electrical receptacle 122 and at least one uncontrolled electrical receptacle 122 in a face of the housing. Alternately preferably the end housing would not contain receptacles, but still house a 3-way switch. Alternately preferably, the end housing 120 may further comprise at least one USB charging port 128, 220 on a face of the end housing 120.

As shown in FIG. 4B, the end housing is preferably electrically connected by way of the 6-conductor wire which electrically connects the end housing to the second housing. The 6-conductor wire connects to at least one controlled electrical receptacle and at least one uncontrolled electrical line 222 from the second housing. FIG. 4B further illustrates how a multiple pole switch 224 and both a controlled and uncontrolled electrical outlet are wired to a wire electrically coupling the end housing to the second housing. The at least one controlled electrical receptacle and at least one uncontrolled electrical receptacle are preferably flush against the housing.

The present invention as described is intended to be used in a way where one controlled and one uncontrolled outlet is available at the first housing, the second housing, and at the end housing. Further, the present invention as described is intended to allow the user to control the controlled outlet from any of the connected switches, including the existing installed household wall switch, the switch on the second housing, or the switch on the end housing. Alternately preferably, any of the first housing, second housing, or end housing may contain a switch. Alternately preferably, any of the first housing, second housing, or end housing may not contain a switch. Alternately preferably, any of the first housing, second housing, or end housing may contain controlled or uncontrolled electrical receptacles. Alternately preferably, any of the first housing, second housing, or end housing may not contain electrical receptacles.

Although the present invention has been described by way of example, it should be appreciated that variations and modifications may be made without departing from the scope of the invention. Furthermore, where known equivalents exist to specific features, such equivalents are incorporated as if specifically referred to in this specification.

I claim:

1. An electrical control device capable of controlling an electronic device from two or more locations utilizing an existing single-pole wall switch and a half/split-circuit receptacle comprising:
a first housing, further comprising in electrical connection at least two sets of male pronged grounded power input plugs and a non-latching relay, wherein said first housing is configured and arranged to provide at least one system-controlled outlet;
a second housing, further comprising in electrical connection a multiple pole switch; and
a wire electrically connecting said first housing to said second housing;
wherein said at least two sets of male pronged grounded power input plugs are isolated, and said non-latching relay is configured and adapted to allow said multiple pole switch in said second housing to turn on and off said at least one system-controlled outlet.

2. The electrical control device of claim 1, further comprising an end housing, wherein said end housing is configured and arranged to provide a third switch.

3. The electrical control device of claim 1 wherein said first housing is configured to plug into a standard household electrical outlet.

4. The electrical control device of claim 1, wherein said first housing further comprises at least one uncontrolled USB charging port.

5. The electrical control device of claim 1, wherein said second housing further comprises a non-latching relay; at least one controlled receptacle; and at least one uncontrolled receptacle in electrical connection.

6. The electrical control device of claim 5, wherein said second housing further comprises at least one uncontrolled USB charging port.

7. The electrical control device of claim 1, wherein said first housing further comprises a remote circuit configured to wirelessly control said multiple pole switch.

8. The electrical control device of claim 1, wherein said multiple pole switch is a three-way switch.

9. The electrical control device of claim 1, wherein said multiple pole switch is a four-way switch.

10. The electrical control device of claim 3, wherein said multiple pole switch is a three-way switch.

11. The electrical control device of claim 3, wherein said multiple pole switch is a four-way switch.

12. An electrical control device capable of controlling at least one electrical device from two or more locations utilizing an existing single-pole wall switch and a half/split-circuit receptacle comprising:
a first housing, further comprising in electrical connection at least two sets of male pronged grounded power input plugs, at least one controlled electrical receptacle, and at least one uncontrolled receptacle, wherein said first housing is configured and arranged to provide at least one system-controlled electrical outlet;
a second housing, further comprising a multiple pole switch, a non-latching relay, at least one controlled electrical receptacle, and at least one uncontrolled electrical receptacle, and a wire electrically connecting said first housing to said second housing;
wherein said at least two sets of male pronged grounded power input plugs are isolated;
wherein at least one set of male pronged grounded power input plug is controlled and at least one set of male pronged grounded power input plug is uncontrolled;
wherein said non-latching relay is configured and adapted to allow said multiple pole switch in said second housing to turn on and off said system-controlled electrical outlet;
and wherein said first housing is configured to plug into a standard household electrical outlet.

13. The lamp control device of claim 12, wherein said first housing further comprises at least one uncontrolled USB charging port.

14. The electrical control device of claim 12, further comprising an end housing comprising; a multiple pole switch; at least one controlled receptacle; and at least one uncontrolled receptacle; and a second wire electrically connecting said first housing to said second housing.

15. The electrical control device of claim 14, wherein said third housing further comprises at least one uncontrolled USB charging port.

16. The electrical control device of claim 12, wherein said first housing further comprises a LED night light electrically connected with a photo cell.

17. The electrical control device of claim 14, wherein said multiple pole switch is a three-way switch.

18. The electrical control device of claim 14, wherein said multiple pole switch is a four-way switch.

19. The electrical control device of claim 12, wherein said multiple pole switch is a three-way switch.

20. The electrical control device of claim 12, wherein said multiple pole switch is a four-way switch.
